(19) United States
(12) Patent Application Publication
(10) Pub. No.: US 2025/0300317 A1
(43) Pub. Date: Sep. 25, 2025

(54) BATTERY CELL SEPARATOR

(71) Applicant: GM Global Technology Operations LLC, Detroit, MI (US)

(72) Inventor: Seung-Woo Chu, Sterling Heights, MI (US)

(21) Appl. No.: 18/612,366

(22) Filed: Mar. 21, 2024

(51) Int. Cl. H01M 50/457; H01M 50/417; H01M 50/431; H01M 50/446

(52) U.S. Cl. CPC H01M 50/457; H01M 50/417; H01M 50/431; H01M 50/446; H01M 2220/20

(57) ABSTRACT

A separator for a battery cell includes a primary layer comprising a porous battery separator material, a thermal stability coating applied onto the primary layer on a surface of the primary layer that will be facing an anode within the battery cell, at least one of a first edge and a second edge of the primary layer including an un-coated zone wherein the thermal stability coating is not applied, and a metallic coating applied onto the primary layer within the un-coated zone.

### INTRODUCTION

The present invention relates generally to a separator for an electrochemical energy storage device such as a Li-ion battery cell, and more particularly to a separator having a thermal stability coating in conjunction with a metallic coating.

The current generation of Li-ion batteries use porous polyolefin separators which are susceptible to thermal shrinkage at elevated temperatures and may cause an electrical short between positive and negative electrodes or the corresponding current collectors. A ceramic coating on the separator helps to inhibit direct contact and provides thermal stability, however, separators comprising porous polyolefin and ceramic materials are not able to be inspected using non-destructive techniques.

Thus, while current separators achieve their intended purpose, there is a need for a new and improved separator for a battery cell that comprises a metallic coating in conjunction with the ceramic coating to provide thermal stability while providing the ability to inspect the separator using non-destructive techniques, such as with x-rays.

### SUMMARY

According to several aspects of the present disclosure, a separator for a battery cell includes a primary layer comprising a porous battery separator material, a thermal stability coating applied onto the primary layer on a surface of the primary layer that will be facing an anode within the battery cell, at least one of a first edge and a second edge of the primary layer including an un-coated zone wherein the thermal stability coating is not applied, and a metallic coating applied onto the primary layer within the un-coated zone.

According to another aspect, the separator further includes a gap between the thermal stability coating and the metallic coating.

According to another aspect, the porous battery separator material is a porous polyolefin comprising one of polyethylene (PE), polypropylene (PP), or a PE/PP hybrid.

According to another aspect, the thermal stability coating is one of a ceramic material, a metal oxide/metal hydroxide, or a pore-controllable polyamine (PAI) layer.

According to another aspect, the metallic coating is one of a polymer binder with metallic particles suspended therein, a metallic layer applied to the primary layer by electrodeless plating, or a metallic layer applied to the primary layer by vapor deposition methods.

According to another aspect, the metallic coating comprises one of aluminum, stainless steel, iron or iron oxide.

According to another aspect, the separator further includes an electrically insulating coating applied over the un-coated zone of the primary layer and the metallic coating.

According to another aspect, the primary layer is approximately ten microns thick, the thermal stability coating is approximately three microns thick, a width of the metallic coating is at least ten microns, and a width of the gap between the thermal stability layer and the metallic coating is at least one micron.

According to several aspects of the present disclosure, a battery cell includes an anode layer, a cathode layer and a separator positioned between the anode layer and the cathode layer, the separator including a primary layer comprising a porous battery separator material, a thermal stability coating applied onto the primary layer on a surface of the primary layer facing the anode, at least one of a first edge and a second edge of the primary layer including an un-coated zone wherein the thermal stability coating is not applied, and a metallic coating applied onto the primary layer on the surface of the primary layer facing the anode within the un-coated zone.

According to several aspects of the present disclosure, a vehicle includes at least one battery cell adapted to store electric energy for the vehicle, the battery cell having an anode layer, a cathode layer and a separator positioned between the anode layer and the cathode layer, the separator including a primary layer comprising a porous polyolefin comprising one of polyethylene (PE), polypropylene (PP), or a PE/PP hybrid, a thermal stability coating comprising one of a ceramic material, a metal oxide/metal hydroxide, or a pore-controllable polyamine (PAI) layer applied onto the primary layer on a surface of the primary layer facing the anode, at least one of a first edge and a second edge of the primary layer including an un-coated zone wherein the thermal stability coating is not applied, and a metallic coating applied onto the primary layer on the surface of the primary layer facing the anode within the un-coated zone.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having a battery system with at least one battery cell in accordance with an exemplary embodiment of the present disclosure;

FIG. 2 is a schematic cut-away view of a battery cell having a separator in accordance with an exemplary embodiment;

FIG. 3 is a sectional view of a cathode layer, separator and anode layer of the battery cell shown in FIG. 2, taken along line 3-3 in FIG. 2;

FIG. 4 is an enlarged portion of the separator shown in FIG. 3, as indicated by the circled portion of FIG. 3 labeled “FIG. 4”; and

FIG. 5 is an enlarged view similar to FIG. 4, wherein the separator includes an electrically insulated coating over the un-coated portion of the primary layer.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and non-vehicle related consumer electronic components.

Lithium-ion batteries and battery cells generally take on one of three traditional forms, cylindrical, prismatic, and pouch types. Each of these battery types offers a set of advantages and disadvantages. The type of battery determines many production factors, for example, each battery form may have a different temperature distribution and heat transfer model.

A cylindrical cell consists of sheet-like anodes, separators, and cathodes that are sandwiched, rolled up, and packed into a cylinder-shaped can. This type is one of the first mass-produced types of batteries. Cylindrical cells are well suited for automated manufacturing and provide good mechanical stability. The round shape of the battery distributes internal pressure from side reactions over the cell circumference almost evenly, allowing the cell to tolerate a higher level of internal pressure without deformation. However, when combining cylindrical cells into packs and modules, the cell's circular cross-section does not allow full utilization of available space, and, as a result, the packaging density of cylindrical cells is low. However, thermal management of a pack of cylindrical cells can be easier because space cavities allow coolant to easily circulate around the cells within a battery pack.

Prismatic cells consist of large sheets of anodes, cathodes, and separators sandwiched, rolled up, and pressed to fit into a metallic or hard-plastic housing in cubic form. The electrodes can also be assembled by layer stacking rather than jelly rolling. Parts of the electrode and separator sheets of a prismatic cell that are close to the container corners can experience more stress. This can damage electrode coatings and lead to non-uniform distribution of the electrolyte. When combining prismatic cells into packs, the cell box-like shape enables optimal use of available space, however, this efficient use of space is achieved with less efficient thermal management because there are no space cavities between the cells as there are in a pack of cylindrical cells.

Pouch cells do not have a rigid enclosure and instead use a sealed flexible foil as the cell container. This packaging reduces weight and leads to flexible cells that can easily fit the available space of a given product, however, pouch cells can swell with gas during charge and discharge. The electrode and separator layers of a pouch cell are stacked rather than jelly rolled. With pouch cells, battery and product design must account for cell swelling by as much as 8% to 10%. Further, due to the cell's soft construction, a support structure is required with pouch cells and the cell should not be placed near sharp edges.

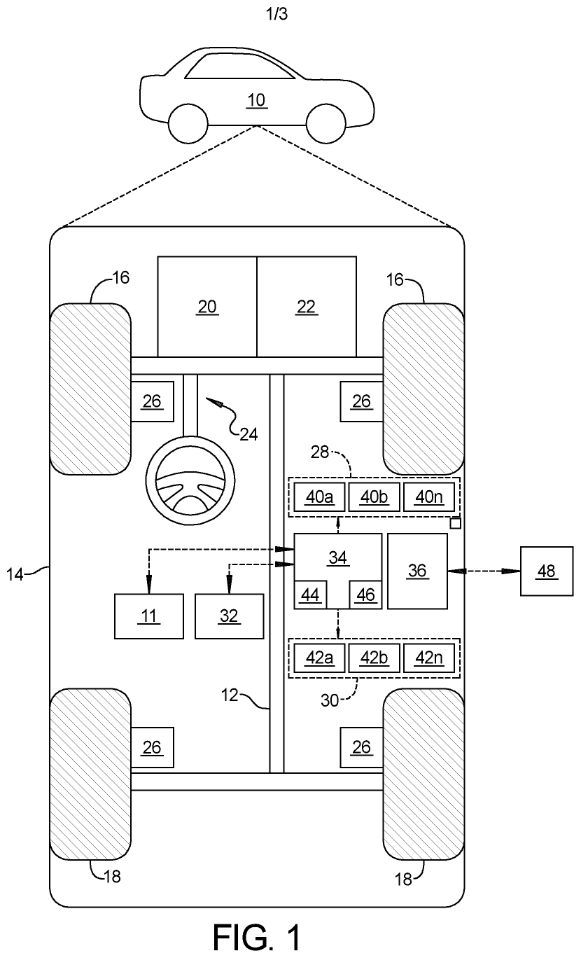

In accordance with an exemplary embodiment of the present disclosure, FIG. 1 shows a vehicle 10 with an associated battery system 11 for storing and supplying electrical energy to the vehicle 10. In general, the battery system 11 works in conjunction with other systems within the vehicle 10 to provide power to either or both an electric propulsion system within the vehicle and/or the various systems within the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 11 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, the propulsion system may include one or more electric motors that are connected to and powered by the battery system 11, and there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

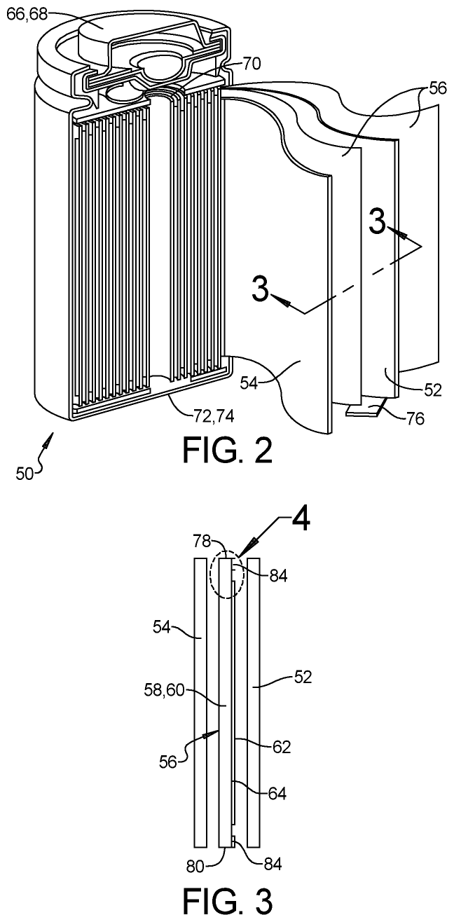

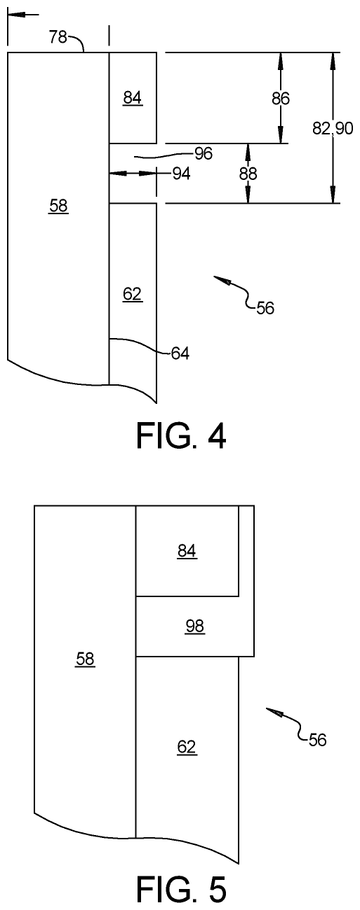

Referring to FIG. 2, a battery cell 50 for the battery system 11 includes an anode layer 52, a cathode layer 54 and a separator 56 positioned between the anode layer 52 and the cathode layer 54. As shown, the battery cell 50 is a cylindrical lithium-ion (LI-ION) battery cell. It should be understood that the novel features of the present disclosure are applicable to any type of battery cell 50 including an anode 52, a cathode 54, and a separator 56 therebetween as well as to non-LI-ION battery cells.

Referring again to FIG. 2, and FIG. 3 and FIG. 4, the separator 56 includes a primary layer 58 comprising a porous battery separator material 60. In an exemplary embodiment, the porous battery separator material 60 is a porous polyolefin comprising one of polyethylene (PE), polypropylene (PP), or a PE/PP hybrid. The porous primary layer 58 is used to contain electrolyte and prevent physical contact (electron-conducting contact) between the anode layer 52 and the cathode layer 54. Many battery cells 50 may be arranged in series or parallel electrical current flow connection, or any suitable combination thereof, to meet the electrical potential and power requirements of the battery system 11.

The lithium-ion battery cell 50 generally operates by reversibly passing lithium ions between a negative electrode (anode layer 52) and a positive electrode (cathode layer 54). The primary layer 58 of the separator is soaked with an electrolyte solution suitable for conducting lithium ions back and forth between the anode layer 52 and the cathode layer 54. Each of the anode layer 52 and the cathode layer 54 are further carried on or connected to a metallic current collector (typically copper for the anode layer 52 and aluminum for the cathode layer 54). During battery usage, the current collectors associated with the anode layer 52 and the cathode layer 54 are connected by a controllable and interruptible external circuit that allows an electron current to pass between the anode layer 52 and the cathode layer 54 to electrically balance the related transport of lithium ions through the battery cell 50. Many different materials may be used to produce these various components of a lithium-ion battery. But in general, the anode layer 52 typically comprises a lithium insertion material or alloy host material, the cathode layer 54 typically comprises a lithium-containing active material that can store lithium at higher potential (relative to a lithium metal reference electrode) than the host material of the anode layer 52, and the electrolyte solution typically contains one or more lithium salts dissolved and ionized in a non-aqueous solvent. The contact of the anode layer 52 and the cathode layer 54 with the electrolyte results in an electrical potential between the anode layer 52 and the cathode layer 54 and, when an electron current is exploited in an external circuit between the anode layer 52 and the cathode layer 54, the potential is sustained by electrochemical reactions within the battery cell 50.

The lithium-ion battery cell 50, or a plurality of lithium-ion battery cells 50 that are connected in a series or a parallel arrangement (or any suitable combination thereof) for current flow, can be utilized to reversibly supply power to an associated load device. The battery system 11 delivers electrical power on demand to a load device such as an electric motor until the lithium content of the anode layer 52 (negative electrode) has been depleted to a predetermined level. The battery cell 50 may then be re-charged by passing a suitable direct electrical current in the opposite direction between the anode layer 52 and the cathode layer 54.

At the beginning of the discharge, the anode layer 52 contains a high concentration of intercalated lithium while the cathode layer 54 is relatively depleted. The establishment of a closed external circuit between the anode layer 52 and the cathode layer 54 under such circumstances causes the transport of intercalated lithium from the anode layer 52. The intercalated lithium is oxidized into lithium ions and electrons. The lithium ions are carried from the anode layer 52 (negative electrode) to the cathode layer 54 (positive electrode) through the ionically conductive electrolyte solution contained in the pores of the porous polyolefin primary layer 58 of the separator 56 while, at the same time, the released electrons are transmitted through the external circuit from the anode layer 52 (negative electrode) to the cathode layer 54 (positive electrode) (with the help of the current collectors), to balance the overall reaction occurring in the electrochemical battery cell 50. The lithium ions are assimilated into the material of the cathode layer 54 by an electrochemical reduction reaction. The flow of electrons through the external circuit can power a load device until the level of intercalated lithium in the anode layer 52 falls below a workable level or the need for power ceases.

The battery cell 50 may be recharged after a partial or full discharge of its available capacity. To charge or re-power the lithium-ion battery cell 50, an external power source is connected to the cathode layer 54 and the anode layer 52 to drive the reverse of battery discharge electrochemical reactions. That is, during charging, the lithium within the cathode layer 54 is oxidized to yield lithium cations and electrons. The cations transport across the separator 56 to the anode layer 52, and the electrons travel through the external circuit to the anode layer 52 as well. At the surface of the anode layer 52, the lithium cations are reduced to lithium by combining with the available electrons within the anode layer 52, and the lithium content of the anode layer 52 increases. Overall, the charging process reduces the lithium content within the cathode layer 54 and increases the lithium content within the anode layer 52.

The separator 56 serves an important function in the battery cell 50. In many lithium-ion battery constructions the anode layer 52 and the cathode layer 54 are formed as thin, compacted, polymer bonded, particulate material layers on their respective current collectors (for example, copper or aluminum foils) and each cell 50 is assembled with a thin, porous, polyolefin separator 56 inserted between the facing electrode layers. Thus, the pores and surfaces of the polyolefin primary layer 58 of the separator 56 are filled and contacted with a lithium ion-containing, non-aqueous electrolyte that contacts and wets the facing anode layer 52 and cathode layer 54 to enable the flow of lithium ions and counter-ions through the pores of the separator 58 and between the anode layer 52 and cathode layer 54. But the polymeric primary layer 58 of the separator 56 resists the flow of electrons directly between the anode layer 52 and the cathode layer 54.

Properties of the separator 56 play an important role in determining the thermal response of the battery cell 50 during an abuse event. Commercial state-of-the-art polyolefin-based separators 56 are generally comprised of polyethylene (PE), polypropylene (PP), or hybrids of PE and PP. While PE and PP-based materials offer excellent mechanical properties, they are susceptible to thermal failure because of their relatively low transition temperatures (135° C. for PE and 165° C. for PP). Additionally, polyolefin-based materials generally display poor wetting properties with carbonate-based electrolytes used in LI-ION battery cells 50. Layering PP and PE can take advantage of the difference in the melting point of PP and PE, using PE as the shutdown layer and PP to protect structural integrity. Unfortunately, such protection is only effective below the melting point of PP.

The separator 56 of the present disclosure further includes a thermal stability coating 62 applied onto the primary layer 58 on a surface 64 of the primary layer 58 facing the anode layer 52. In an exemplary embodiment, the thermal stability coating 62 comprises a thin layer of a ceramic material such as silica or alumina, or a thin layer of metal oxides or metal hydroxide, such as boehmite. In a non-limiting example, the primary layer 58 is surface coated with polymer-bonded particles of such ceramic material or metal oxides. The thermal stability coating 62 increases the strength of the separator 56, increases dimensional stability of the separator 56 at high temperatures (above which polymers such as PE or PP would exist in a molten state), and increases electrolyte retention capability of the primary layer 58 of the separator 56. In another exemplary embodiment, the thermal stability coating comprises a pore-controlled polyamine (PAI). PAI is applied to the primary layer 58 using a phase transfer and gravure-printing method. The PAI provides a pore controllable structure with varying pore sizes. For example, pore sizes may vary between 0.02 microns, 0.17 microns and 0.85 microns. The thermal stability coating 62 made from PAI provides the advantage of “Guest-Host Transition”, wherein the PAI undergoes a reversible transition, enhancing thermal stability, and “Pore On/Off”, wherein ion transfer across the separator can be selectively turned on or off by using the PAI to close pores within the PE primary layer 58.

Referring again to FIG. 2, the battery cell 50 includes several alternating layers of anode layer 52/separator 56/cathode layer 54 wrapped in a cylindrical shape. As shown, the battery cell 50 includes a first end 66 including a positive cap 68 electrically connected to a positive tab 70 that is connected to the cathode layer 54 (cathode layers 54). The battery cell 50 further includes a second end 72 including a negative cap 74 electrically connected to a negative tab 76 that is connected to the anode layer 52 (anode layers 52). The primary layer 58 of the separator 56 includes a first edge 78 that extends circumferentially around the cylindrical battery cell 50 adjacent the first end 66 of the battery cell 50 and a second edge 80 that extends circumferentially around the cylindrical battery cell 50 adjacent the second end 72. In an exemplary embodiment, at least one of the first edge 78 and the second edge 80 of the primary layer 58 of the separator 56 includes an un-coated zone 82 wherein the thermal stability coating 62 is not applied. The battery cell 50 may include an un-coated zone 64 adjacent either one or both of the first and second edges 78, 80.

During manufacture, the first and second edges 78, 80 of the separator 56 are at risk for damage from bumping against other objects, etc. Thus, for quality control reasons, during mass production, it is desirable to test completed battery cells 50 to ensure that the first and second edges 78, 80 have not been damaged. Non-destructive testing methods, such as x-ray inspection, are not viable due to the polymeric and ceramic/metal oxide nature of the primary layer 58 and thermal stability coating 62. Thus, typically, random periodic teardowns (destructive testing) are performed to see if the battery cells 50 being manufactured have damaged/defective separators 56 by visual inspection. This involves the loss of the battery cell 50 that is torn down, and does not provide 100% testing for the manufactured battery cells 50.

To allow each battery cell 50 to be inspected using non-destructive techniques (x-ray inspection), in an exemplary embodiment, the separator 56 includes a metallic coating 84 applied onto the primary layer 58 on the surface 64 of the primary layer 58 facing the anode layer 52 within the un-coated zone 82. Referring again to FIG. 4, in an exemplary embodiment, a width of the metallic coating 84 is at least ten microns, as indicated at 86, and the separator 56 includes a gap 96 of at least one micron between the metallic coating 84 and the thermal stability coating 62, as indicated at 88. Thus, a minimum width of the uncoated zone 82 is at least eleven microns, as indicated at 90.

The metallic coating 84 may be any metallic material that can be detected using x-ray methods. In an exemplary embodiment, the metallic coating 84 comprises one of aluminum or stainless steel. Aluminum is often the metallic material used in the metallic coating 84 due to electrochemical stability, however, aluminum tends to show weak response when using x-ray methods as compared to other metallic materials. When using aluminum, aluminum image processing techniques and algorithms may be utilized to improve the responsiveness of aluminum in x-ray images. A metallic coating comprising iron (Fe) or iron oxide (FeO₂) material provides optimal visibility using x-ray methods, and provides no negative impact on the performance of the battery cell 50. Unlike aluminum, iron-based metal oxides are stable in anode potential within the lithium-ion battery cell 50.

The metallic coating 84 may be applied to the surface 64 of the primary layer 58 facing the anode layer 52 by any known methods or processes. In an exemplary embodiment, the metallic coating 84 comprises metallic particles or powder suspended within a matrix or binder of polymeric material. During application, the polymeric material is a liquid slurry and the metallic particles/powder are mixed into the slurry along with surfactant and a rheology modifier. The slurry with the metallic particles/powder and other components is then applied to the surface 64 of the primary layer 58 facing the anode layer 52 using wet coating and solvent drying techniques. This method of application reduces the occurrence of metallic contamination and the metallic coating 84 can be prepared and applied simultaneously with the thermal stability coating 62. However, in other embodiments, the metallic coating 84 may be applied to the surface 64 of the primary layer 58 facing the anode layer 52 using electrodeless plating methods or vacuum deposition such as, by way of non-limiting examples, physical vapor deposition (PVD) or chemical vapor deposition (CVD) methods.

Physical vapor deposition techniques such as electron beam physical vapor deposition (EB-PVD) and magnetron sputtering, pulsed laser deposition (PLD) can be used to deposit binder-free, ceramic (inorganic) thin films with better thickness and morphology control than the slurry-coating technique. Among thin film deposition methods, EB-PVD is a fast (2 nm/s) and scalable process that produces dense, uniform ceramic layer, and does not require post fabrication conditioning. It employs an electron beam (EB) source that can evaporate a target at a very high rate (approximately 2 nm/s) and deposit on a fixed large surface area or roll-to-roll fabrication required for large-scale battery manufacturing.

As shown in FIG. 2, the positive tab 70 (cathode tab) is located at the first end 66 of the battery cell 50 and the negative tab 76 (anode tab) is located at the second end 72 of the battery cell 50. In other embodiments, when the negative tab 76 is located at the same end of the battery cell 50 as the positive tab 70, the separator 56 further includes an electrically insulating coating 98 applied over the un-coated zone 82 of the primary layer 58 and the metallic coating 84.

Referring again to FIG. 4, in an exemplary embodiment, the primary layer 58 is approximately ten microns thick, as indicated at 92, and the thermal stability coating 62 is approximately three microns thick, as indicated at 94, wherein the term “approximately”, as used herein, is defined as plus or minus two microns. It should be understood by those skilled in the art that the primary layer 58 and the thermal stability layer 62 may have other thicknesses depending on design constraints/requirements.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A separator for a battery cell, comprising:
a primary layer comprising a porous battery separator material;
a thermal stability coating applied onto the primary layer on a surface of the primary layer that will be facing an anode within the battery cell;
at least one of a first edge and a second edge of the primary layer including an un-coated zone wherein the thermal stability coating is not applied; and
a metallic coating applied onto the primary layer within the un-coated zone.

2. The separator of claim 1 further including a gap between the thermal stability coating and the metallic coating.

3. The separator of claim 2, wherein the porous battery separator material is a porous polyolefin comprising one of polyethylene (PE), polypropylene (PP), or a PE/PP hybrid.

4. The separator of claim 2, wherein the thermal stability coating is one of:
a ceramic material;
a metal oxide/metal hydroxide; or
a pore-controllable polyamine (PAI) layer.

5. The separator of claim 2, wherein the metallic coating is one of:
a polymer binder with metallic particles suspended therein;
a metallic layer applied to the primary layer by electrodeless plating; or a metallic layer applied to the primary layer by vapor deposition methods.

6. The separator of claim 2, wherein the metallic coating comprises one of aluminum, stainless steel, iron or iron oxide.

7. The separator of claim 2, further including an electrically insulating coating applied over the un-coated zone of the primary layer and the metallic coating.

8. The separator of claim 2, wherein:
the primary layer is approximately ten microns thick;
the thermal stability coating is approximately three microns thick;
a width of the metallic coating is at least ten microns; and
a width of the gap between the thermal stability layer and the metallic coating is at least one micron.

9. A battery cell having an anode layer, a cathode layer and a separator positioned between the anode layer and the cathode layer, the separator comprising:
a primary layer comprising a porous battery separator material;
a thermal stability coating applied onto the primary layer on a surface of the primary layer facing the anode;
at least one of a first edge and a second edge of the primary layer including an un-coated zone wherein the thermal stability coating is not applied; and
a metallic coating applied onto the primary layer on the surface of the primary layer facing the anode within the un-coated zone.

10. The battery cell of claim 9 wherein the separator includes a gap between the thermal stability coating and the metallic coating.

11. The battery cell of claim 10, wherein the porous battery separator material is a porous polyolefin comprising one of polyethylene (PE), polypropylene (PP), or a PE/PP hybrid.

12. The battery cell of claim 10, wherein the thermal stability coating is on of:
a ceramic material;
a metal oxide/metal hydroxide; or
a pore-controllable polyamine (PAI) layer.

13. The battery cell of claim 10, wherein the metallic coating is one of:
a polymer binder with metallic particles suspended therein;
a metallic layer applied to the primary layer by electrodeless plating; or
a metallic layer applied to the primary layer by vapor deposition methods.

14. The battery cell of claim 10, wherein the metallic coating comprises one of aluminum, stainless steel, iron or iron oxide.

15. The battery cell of claim 10, further including an electrically insulating coating applied over the un-coated zone of the primary layer and the metallic coating.

16. The battery cell of claim 10, wherein:
the primary layer is approximately ten microns thick;
the thermal stability coating is approximately three microns thick;
a width of the metallic coating is at least ten microns; and
a width of the gap between the thermal stability coating and the metallic coating is at least one micron.

17. A vehicle having at least one battery cell adapted to store electric energy for the vehicle, the battery cell having an anode layer, a cathode layer and a separator positioned between the anode layer and the cathode layer, the separator comprising:
a primary layer comprising a porous polyolefin comprising one of polyethylene (PE), polypropylene (PP), or a PE/PP hybrid;
a thermal stability coating comprising one of a ceramic material, a metal oxide/metal hydroxide, or a pore-controllable polyamine (PAI) layer applied onto the primary layer on a surface of the primary layer facing the anode;
at least one of a first edge and a second edge of the primary layer including an un-coated zone wherein the thermal stability coating is not applied; and
a metallic coating applied onto the primary layer on the surface of the primary layer facing the anode within the un-coated zone.

18. The vehicle of claim 17 wherein the separator includes a gap between the thermal stability coating and the metallic coating.

19. The vehicle of claim 18, wherein the metallic coating comprises a metallic material including one of aluminum, stainless steel, iron or iron oxide, and is one of:
a polymer binder with metallic particles suspended therein;
a metallic layer applied to the primary layer by electrodeless plating; or
a metallic layer applied to the primary layer by vapor deposition methods.

20. The vehicle of claim 19, further including an electrically insulating coating applied over the un-coated zone of the primary layer and the metallic coating.
